(19) United States
(12) Patent Application Publication
(10) Pub. No.: US 2018/0181284 A1
(43) Pub. Date: Jun. 28, 2018

(54) SCREEN RECORDING METHOD AND APPARATUS IN TERMINAL

(71) Applicant: Samsung Electronics Co., Ltd., Gyeonggi-do (KR)

(72) Inventor: Je-Han YOON, Gyeonggi-do (KR)

(21) Appl. No.: 15/901,463

(22) Filed: Feb. 21, 2018

Related U.S. Application Data
(63) Continuation of application No. 14/012,491, filed on Aug. 28, 2013.

(30) Foreign Application Priority Data
Aug. 29, 2012 (KR) 10-2012-0095221

(51) Int. Cl. G06F 3/0484; G06F 3/0488; G06F 3/0481

(52) U.S. Cl. CPC G06F 3/04842; G06F 2203/04804; G06F 3/0481; G06F 3/0488

(57) ABSTRACT

A screen recording method and apparatus, and a recording medium for storing program sources for the method are provided. The screen recording method in a terminal includes displaying a first screen; executing a screen recording function for recording the first screen; detecting a first touch input on the first screen while recording the first screen; generating a first image effect indicating at least one of a location and movement of the first touch input on the first screen; and storing a video file including the recorded first screen combined with the generated first image effect.

### PRIORITY

This application is a Continuation of U.S. application Ser. No. 14/012,491, which was filed in the U.S. Patent and Trademark Office on Aug. 28, 2013, and claims priority under 35 U.S.C. § 119(a) to Korean Patent Application Serial No. 10-2012-0095221, which was filed in the Korean Intellectual Property Office on Aug. 29, 2012, the content of each of which is incorporated herein in its entirety by reference.

### BACKGROUND

### 1. Field

The present invention generally relates to a screen recording method and apparatus, and a recording medium for storing program sources for the method.

### 2. Description of Related Art

In a conventional screen recording method in a large-sized terminal such as a computer, a program for recording a screen is displayed in part of the display area, e.g., in the corner of the display area while a screen to be recorded is reduced and displayed in another part of the display area, e.g., in the center of the display area. With the conventional method, the user may easily record the screen while manipulating the program.

By comparison, in a relatively small-sized portable terminal, e.g., a smailphone, a user interface for screen recording and a display area for a screen to be recorded are hardly distinguished from each other. That is, the user interface for screen recording typically overlays the screen to be recorded.

When screen recording is attempted in a portable terminal, the user interface to start, stop, pause the screen recording and change settings for the screen recording is also recorded as it is, which may lower the User eXperience (UX) for the user who uses the recorded screen.

During screen recording, the user may run or stop an application by selecting a specific icon and/or perform activities or gestures such as touching, dragging or swiping to perform a particular function. Recording the user's activities could provide related information to other people who look at the recorded screen, but there has thus far been no way to record activities of the user.

### SUMMARY

The present invention has been made to address at least the problems and disadvantages described above, and to provide at least the advantages described below.

Accordingly, an aspect of the present invention provides a screen recording method that leaves out a user interface for screen recording from a recording target.

Another aspect of the present invention provides a screen recording method that records user's activities made in the screen recording.

In accordance with an aspect of the present invention, a screen recording method in a terminal is provided. The screen recording method includes displaying a first screen; executing a screen recording function for recording the first screen; detecting a first touch input on the first screen while recording the first screen; generating a first image effect indicating at least one of a location and movement of the first touch input on the first screen; and storing a video file including the recorded first screen combined with the generated first image effect.

In accordance with another aspect of the present invention, an apparatus is provided, which includes a touchscreen display; a memory; and a processor configured to display a first screen on the touchscreen display; execute a screen recording function for recording the first screen; detect a first touch input on the first screen while recording the first screen; generate a first image effect indicating at least one of a location and movement of the first touch input on the first screen; and store, in the memory, a video file including the recorded first screen combined with the generated first image effect.

In accordance with another aspect of the present invention, a screen recording method in a terminal is provided. The screen recording method includes displaying a first screen; executing a screen recording function for recording the first screen; detecting a first touch input on the first screen while recording the first screen; generating a first image effect indicating at least one of a location and movement of the first touch input on the first screen; and storing a video file including the recorded first screen and the generated first image effect.

In accordance with another aspect of the present invention, an apparatus is provided, which includes a touchscreen display; a memory; and a processor configured to display a first screen on the touchscreen display; execute a screen recording function for recording the first screen; detect a first touch input on the first screen while recording the first screen;

generate a first image effect indicating at least one of a location and movement of the first touch input on the first screen; and store, in the memory, a video file including the recorded first screen and the generated first image effect.

### BRIEF DESCRIPTION OF THE DRAWINGS

The above and other aspects, features and advantages of certain embodiments of the present invention will become more apparent by describing in detail embodiments thereof with reference to the accompanying drawings in which:

FIG. 1 is a flowchart illustrating a concept of a screen recording method according to an embodiment of the present invention;

FIGS. 2A to 2E illustrates screens in terms of a screen recording method according to an embodiment of the present invention;

FIG. 3 is a block diagram of a screen recording apparatus according to an embodiment of the present invention;

FIG. 4 is a block diagram of a screen recording apparatus according to another embodiment of the present invention;

FIG. 5 is a block diagram of a screen recording apparatus according to another embodiment of the present invention; and

FIG. 6 is a block diagram of a screen recording apparatus according to another embodiment of the present invention.

Throughout the drawings, like reference numerals will be understood to refer to like parts, components, and structures.

### DETAILED DESCRIPTION

The following description with reference to the accompanying drawings is provided to assist a person of ordinary skill in the art with a comprehensive understanding of the invention. The description includes various specific details to assist in that understanding but these are to be regarded as mere examples for illustrative purposes. Accordingly, those of ordinary skill in the art will recognize that various changes and modifications of the embodiments described herein can be made without departing from the invention. In addition, descriptions of well-known functions and constructions may be omitted for clarity and conciseness when their inclusion may obscure the subject matter of the present invention. Accordingly, it should be apparent to those skilled in the art that the following description of embodiments of the present invention is provided for illustration purposes only and not for the purpose of limiting the invention as defined by the appended claims and their equivalents.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Descriptions shall be understood as to include any and all combinations of one or more of the associated listed items when the items are described by using the conjunctive term “˜ and/or ˜,” or the like.

The terminology used herein is for the purpose of describing particular embodiments only and is not intended to be limiting of the invention. It is to be understood that the singular forms “a,” “an,” and “the” include plural references unless the context clearly dictates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the conventional screen recording method, a user interface for screen recording appears as it is in the recorded screen, lowering the user experience for a user to see a recorded screen. In addition, the user may not deliver to another person any information regarding user activities made while the screen recording is performed.

To address such issues, the present invention provides embodiments of a screen recording method that prevents a user interface for screen recording from appearing in the recorded screen. The present invention also provides embodiments of a screen recording method that enable user activities performed during the screen recording to be included in the recorded screen.

Embodiments of the present invention will now be described with reference to accompanying drawings.

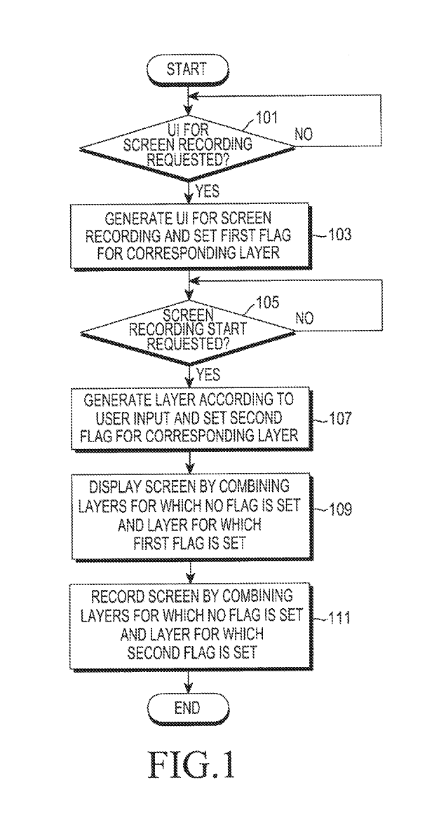

First, a concept of a screen recording method according to embodiments of the present invention is described with reference to FIG. 1.

In step 101, a terminal determines whether a request to run a user interface (UI) for screen recording is made from the user. If the request is made by the user, the process proceeds to step 103. It is assumed that the terminal has been outputting a screen made up of at least one layer. For example, the at least one layer may include one or more of a layer to display a background screen, a layer to display terminal state information, such as time, battery capacity remaining, etc., and a layer to display applications installed in the terminal. The screen may further include a layer to display a status of a particular application running on the screen.

In step 103, the terminal generates the user interface for screen recording and sets a first flag for the layer to display the user interface. “Setting a flag” as used herein may refer to assigning a particular bit to a corresponding layer.

In step 105, the terminal determines if a request to start screen recording is made by the user through the user interface, and starts screen recording if there is the request to start screen recording. The terminal performs screen recording until after the lapse of a predetermined time or a request to stop screen recording is made through the user interface.

In step 107, the terminal generates a layer to display a result in response to a user input and sets a second flag for the layer. The user input may include touching, dragging, and swiping activities made by the user in a predetermined display area. The result in response to the user input may be a display of an image effect for the user input. However, if the user input is an input that manipulates the user interface for screen recording, an image effect corresponding to the user input may not be generated.

In step 109, the terminal displays a screen shown to the user who performs screen recording. Specifically, in step 109, the terminal displays a screen by combining layers for which no flag is set and the layer for which the first flag is set. That is, the terminal displays a screen by combining at least one layer that makes up the screen being displayed before running the user interface for screen recording and the layer to display the user interface for screen recording. The reason that the layer for which the second flag is set is left out from the screen to be displayed is because displaying an image effect for a user input may increase visual complexity which lowers the user experience for the user who performs screen recording.

In step 111, the terminal generates content of the recorded screen. That is, in step 111, the terminal performs screen recording by combining layers for which no flag is set and the layer for which the second flag is set. That is, the terminal performs screen recording by combining at least one layer that makes up the screen being displayed before running the user interface for screen recording and the layer to display an image effect for a user input. The reason that the layer for which the first flag is set is not included in the recording target is because the user experience for a user who may see the recorded screen may be lowered due to the existence of the user interface for screen recording.

While a way to determine whether a layer is a target layer to be recorded or to be displayed by setting a flag for the layer has thus far been described, such a layer may be distinguished in various other ways.

As described above, embodiments of the present invention provide an advantage of improving user experience for both the user who performs screen recording and a user who sees the recorded screen by distinguishing a layer to be displayed in a screen from a layer to be included in the recorded screen.

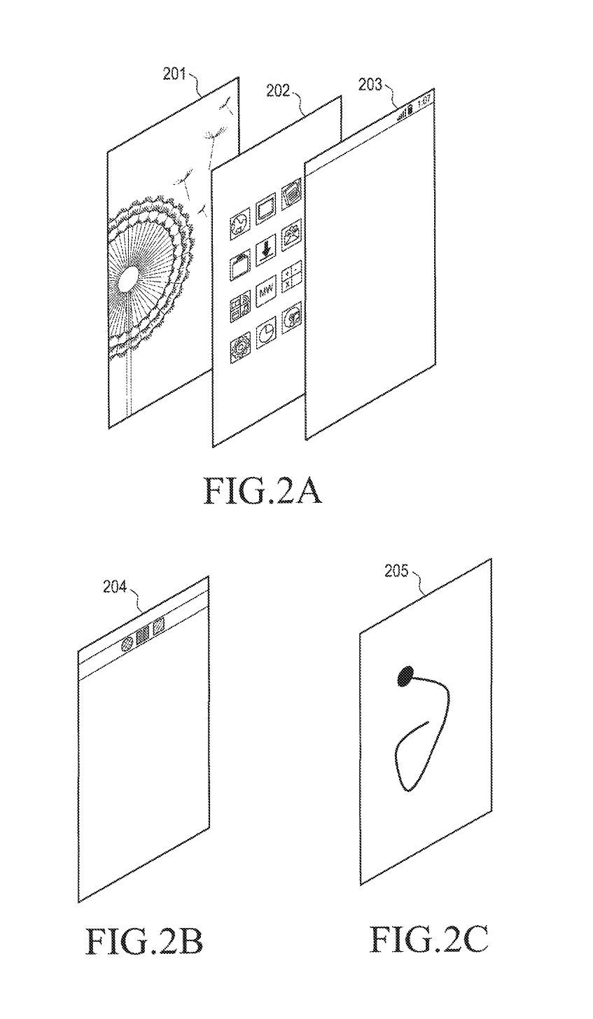

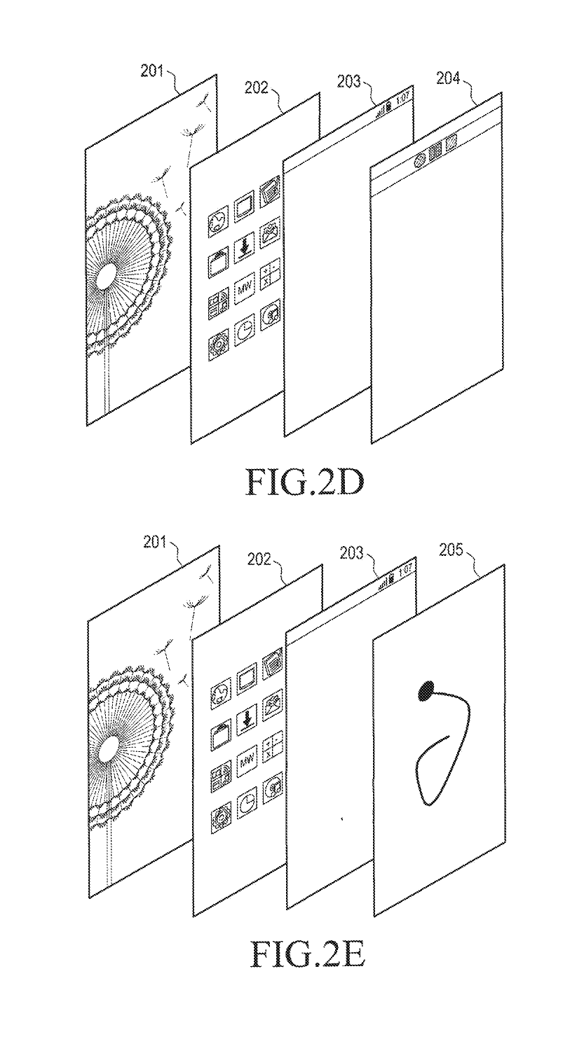

Referring to FIGS. 2A to 2E, a screen recording method according to embodiments of the present invention will be described.

It is assumed that a screen made up of a first layer (layer 1) 201, a second layer (layer 2) 202, and a third layer (layer 3) 203 is displayed in the terminal, as shown in FIG. 2A. Such layers partly or transparently overlap each other, which are visually recognizable to the user.

While displaying the screen, the terminal generates a layer 204 to display a user interface for screen recording at a user's request to run the user interface for screen recording. An example of the layer 204 to display the user interface for screen recording is shown in FIG. 2B. The terminal sets a first flag for the layer 204 in order to prevent the layer 204 from being included in the recorded screen.

After that, the terminal starts screen recording upon request through the user interface. During the screen recording, if the terminal recognizes a user's activity or gesture, e.g., touching and/or dragging of a particular icon or swiping over the screen, the terminal generates a layer 205 to display an image effect for the user's activity while performing the corresponding function. An example of the layer 205, displaying an image effect for a user's activity, in particular, the user's dragging activity, is shown in FIG. 2C. The terminal sets a second flag for the layer 205 in order to prevent the layer 205 from being displayed during the screen recording.

After that, the terminal combines at least one layer for which no flag is set, which are each of layers 1 to 3 (201 to 203) shown in FIG. 2A, and the layer for which the first flag is set, which is the layer 204, to display the user interface for screen recording, and displays the resultant screen. The resultant screen made up of the layers 201 to 204 is shown in FIG. 2D.

The terminal also combines at least one layer for which no flag is set, which are each of layers 1 to 3 (201 to 203) shown in FIG. 2A, and the layer for which the second flag is set, which is the layer 205, to display the image effect for the user input, and records the resultant screen. The resultant screen made up of the layers 201 to 203 and 205 is shown in FIG. 2E.

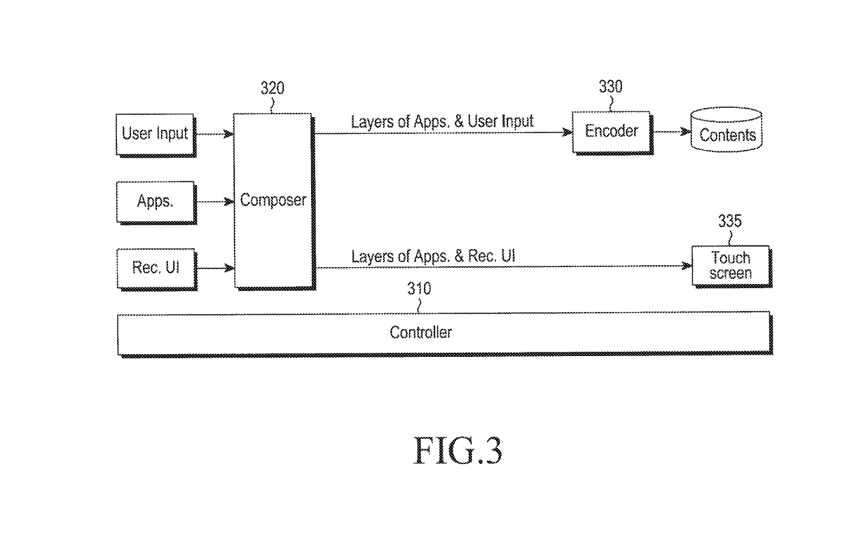

A screen recording apparatus according to embodiments of the present invention will now be described with reference to related figures with respect to FIGS. 3 to 6.

FIG. 3 is a block diagram of a screen recording apparatus according to an embodiment of the present invention.

Referring to FIG. 3, the screen recording apparatus includes a controller 310, a composer 320, and an encoder 330. Although not shown, a touch screen for receiving user inputs and displaying screens and a memory for storing recorded content are also included.

The controller 310 generates layers to display a background screen, terminal state information, and various applications, respectively, and sends the layers to the composer 320. The controller 310 configures a layer to run a user interface for screen recording upon request from the user and sends the layer to the composer 320. The controller 310 also starts to control screen recording upon request through the user interface, and controls to pause, resume, stop or set up screen recording through the user interface according to an input of the user.

The controller 310 also generates a layer to display a status of at least one application running on the terminal if there is a request to run the at least one application, and sends the layer to the composer 320.

The controller 310 also generates a layer to display content upon request to reproduce the content, and sends the layer to the composer 320. The content may be Digital Rights Management (DRM) content, streaming content, or ordinary content stored in the terminal.

The controller 310 also generates a layer to display an image effect for a user input made during the screen recording, and sends the layer to the composer 320. If the user input is to manipulate the user interface for screen recording, an image effect for the user input may not be displayed and thus the layer to display the image effect may not be generated.

The controller 310 sets a flag for a particular layer to be sent to the composer 320. For example, the controller 310 may set a first flag for a layer to be displayed on the screen and set a second flag for a layer to be included in the recorded screen.

While performing the screen recording, the controller 310 may generate a layer to display at least one piece of system information, such as information regarding the state and position of the terminal, various sensing information received from sensors such as a thermometer and a light sensor, information indicating an amount of usage of a Central Processing Unit/Graphic Processing Unit (CPU/GPU) of the terminal, and identification information to identify the user of the terminal. The controller 310 sets a second flag for the layer in order for the layer to be only displayed in the recorded screen.

The composer 320 generates a screen resulting from combination of various layers sent from the controller 310, under control of the controller 310.

The composer 320 sends the generated screen to the touch screen and encoder 330. In this regard, the composer 320 may combine layers to be sent to the touch screen and the encoder 330, differently. For example, the composer 320 may combine layers for which no flag is set and the layer for which the first flag is set and send the resultant screen to the touch screen 335. And, the composer 320 may combine layers for which no flag is set and the layer for which the second flag is set and send the resultant screen to the encoder 330.

The encoder 330 generates content or the recorded screen of the resultant screen sent from the composer 320. The content is stored in the memory.

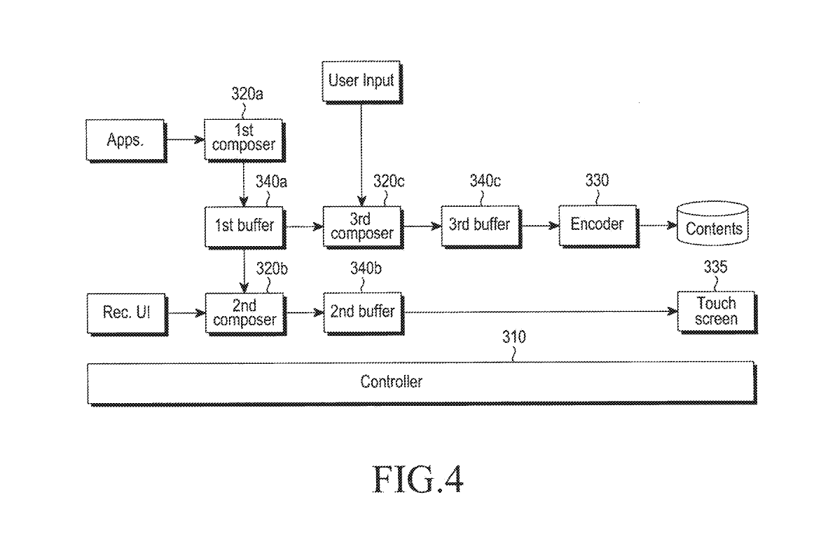

In the embodiment shown in FIG. 3, the composer 320 may be divided into several blocks, and buffers to be used to send layers may further be included in the screen recording apparatus. Such a configuration with such composer 320 and buffers may vary according to different embodiments. An embodiment of the configuration is shown in FIG. 4.

Referring to FIG. 4, the screen recording apparatus includes the controller 310, first to third composers 320a, 320b and 320c, first to third buffers 340a, 340b and 340c, and the encoder 330.

Since the controller 310 has been described in connection with FIG. 3, no further explanation for the controller 310 will be provided herein.

The first to third composers 320a, 320b and 320c share the function of the composer 320, which was described in connection with FIG. 3. The first composer 320a combines layers each to display a status of an application running on the terminal or combines layers to display a background screen and terminal state information, and outputs the combined results to the first buffer 340a.

The second composer 320b generates a screen by combining a layer to display a user interface for screen recording and a layer received from the first buffer 320a and sends the screen to the second buffer 340b. The screen sent to the second buffer 340b is output through the touch screen.

The third composer 320c generates a screen by combining a layer sent from the first buffer 340a and a layer to display an image effect for a user input, and sends the screen to the third buffer 340c.

The encoder 330 generates content, such as video content, by encoding the screen sent from the third buffer 340c. The video content is stored in the memory.

Although not shown in FIG. 4, an image scaler may further be included between the third composer 320c and the third buffer 340c. The image scaler may adjust e.g., screen size and resolution based on settings. The settings may be changed through the user interface for screen recording. If the user requests to change the settings during the screen recording, the controller 310 may pause the screen recording and resume when a change of the settings is complete. This is done to prevent menu manipulation of the user from being included in the recorded screen.

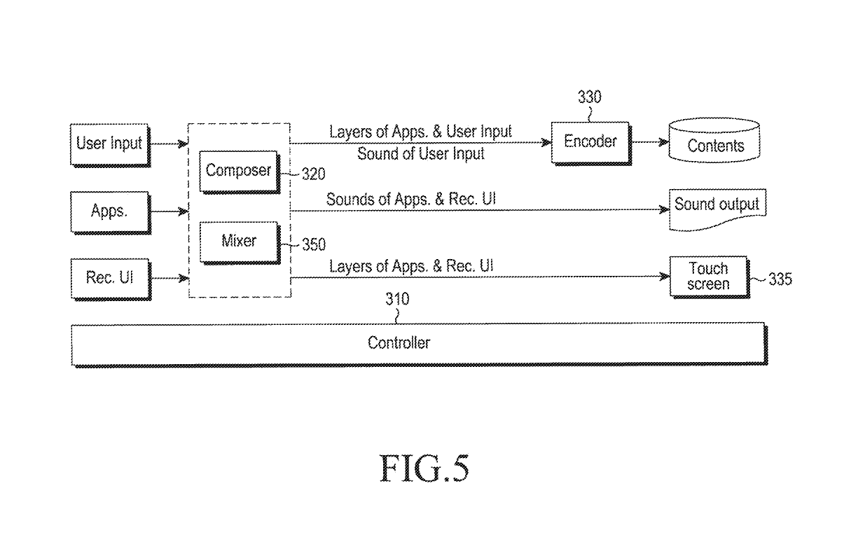

During screen recording, a sound coming from a running application, voice of the user through the microphone, or sound effects for a user activity made on the touch screen may be recorded as well. An embodiment of screen recording with a sound recording function will be described in connection with FIG. 5.

FIG. 5 is a block diagram of a screen recording apparatus according to another embodiment of the present invention. Referring to FIG. 5, the screen recording apparatus includes the controller 310, the composer 320, the encoder 330, and a mixer 350. Since the composer 320 has been described in connection with FIG. 3, no further explanation for the composer 320 will be provided herein.

The controller 310 performs a following operation in addition to the operations described in connection with FIG. 3. During the screen recording, the controller 310 determines whether to record a sound at the same time. The controller 310 may make the determination taking into account settings stored in the memory. If the sound is determined to be recorded at the same time, the controller 310 controls the mixer 350 to generate content in which the sound is recorded together with the screen content. Settings for the sound recording may be changed by the user. For example, the user may determine whether to output a sound generated while an application is manipulated, the user's voice through the microphone or sound effects for the user's activity made on the touch screen through the speaker, or combine them with the screen to be recorded. Taking the settings into account, the controller 310 controls the mixer 350 to perform sound mixing by distinguishing sounds to be combined with the screen to be recorded from a sound to be output through the speaker.

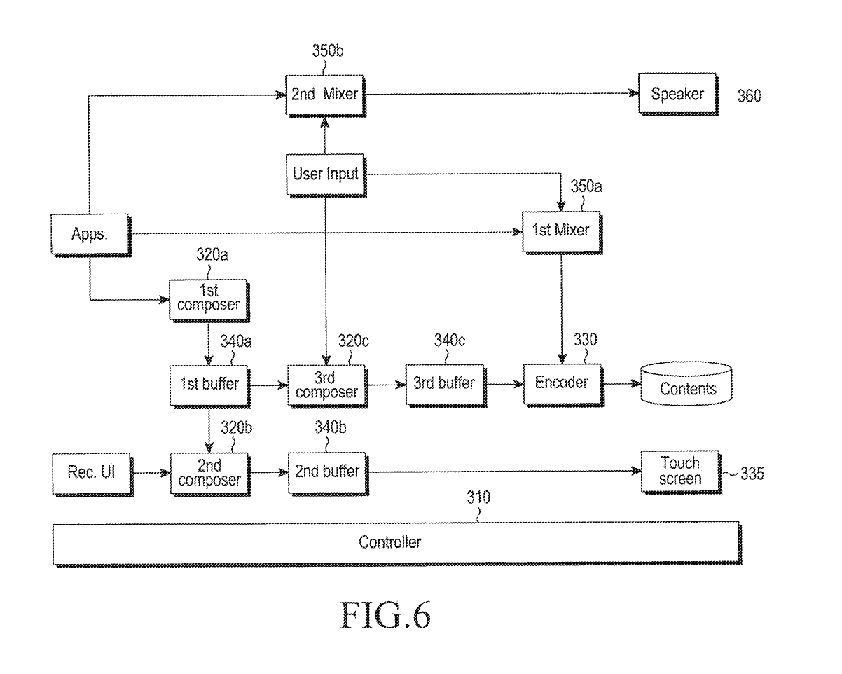

Similar to the composer 320, the mixer 350 may also be divided into several blocks, and configurations of the mixer 350 may vary according to different embodiments. An embodiment of the configuration of the mixer is shown in FIG. 6.

Referring to FIG. 6, the screen recording apparatus includes the controller 310, first to third composers 320a, 320b and 320c, first and second mixers 350a and 350b, first to third buffers 340a, 340b and 340c, and the encoder 330.

The first to third composers 320a, 320b, and 320c and the first to third buffers 340a , 340b, and 340c were described in connection with FIG. 4 and thus further explanation about them will not be provided herein.

During the screen recording, at least one of a sound generated while at least one application is manipulated, voice of the user through the microphone, and a sound effect for a user input on the touch screen is sent to the first and second mixers 350a and 350b.

The first and second mixers 350a and 350b each mix a sound coming from a respective path, under control of the controller 310. The first mixer 350a sends the mixed sound to the encoder 330 and the second mixer 350b outputs the mixed sound through the speaker 360. For example, the first mixer 350a may mix sounds except for the sound generated while the at least one application is manipulated under control of the controller 310 and sends the result to the encoder 330. The second mixer 350b may mix sounds except for the sound effect for the user activity against the touch screen, and then output the result through the speaker 360.

A sound and a screen image are input to the encoder 330 with different paths, which may cause time delays. Thus, the sound and the screen image have to be synchronized. Time stamps may be used to synchronize the sound and the screen image. For example, if a sound effect and an image effect are generated for a user input on the touch screen, time information may be inserted in each of the sound effect and the image effect. The encoder 330 may then generate content by analyzing respective time information and synchronizing the sound effect and the image effect. Alternatively, time information determined in advance through a simulation after the system is configured may be used for the synchronization.

While a recording function is performed, Digital Right Management (DRM) content may be reproduced in a video play application, streaming content from a network, e.g., the Internet, may be reproduced, or a screen for entering a password may be displayed. Such DRM content, streaming content and password enter screen must not appear in the recorded screen. Embodiments will now be provided in this regard, which will be described below, may be applied together with the embodiments described with reference to FIGS. 1 to 6 and may be performed by the screen recording apparatus as described in connection with FIGS. 3 to 6.

A case where DRM content is reproduced will be first described. In the case where the DRM content is reproduced, an application responsible for reproducing the DRM content generates a message to indicate that the DRM content is reproduced and sends the message to the controller 310. Upon reception of the message indicating that the DRM content is reproduced, the controller 310 sets a first flag for a layer to display the DRM content. Then the composer 320 confirms the flag for the layer and leaves the layer out of the screen to be recorded. In this case, the DRM content shown to the user who performs screen recording is not shown in the recorded screen. In another embodiment, instead of setting the first flag for the layer to display the DRM content, a specific image, e.g., a mosaic image, may be displayed where the DRM content is supposed to be displayed, thus generating a recorded screen with the DRM content hidden therefrom. To do this, the controller 310 generates a layer to display the particular image that corresponds to the size and position of the reproduced screen of the DRM content, sets a second flag for the layer, and sends the layer to the composer 320. The particular image may be generated to be opaque, and the layer to display the particular image may be arranged atop. In a case where a sound is output together with the screen, the controller 310 controls a corresponding application to not output the sound from corresponding content to the mixer 350, or controls the mixer 350 to not mix the sound.

The screen recording and sound mixing method in the case of reproduction of the DRM content may be similarly applied to the streaming content. That is, upon reception of a message indicating that the streaming content is reproduced from an application that reproduces streaming content, the controller 310 may set a first flag for a layer to display the streaming content or generate a layer to display a particular image that corresponds to the size and position of an area in which to display the streaming content, set a second flag for the layer, and send the layer for which the second flag is set to the composer 320. In the case where a sound is output together with the screen, the controller 310 controls the mixer 350 to not combine the sound with the screen to be recorded, thus preventing the sound from being recorded together with the screen.

In another embodiment where a layer is configured to display a specific field which is set according to a user input or a user activity, e.g., a specific field for entering a password, the controller 310 sets a first flag for the layer. Whether it is the layer to display the specific field (for entering a password) or not may be determined by analyzing a tag that makes up the specific field. For example, if there is an attribute ‘password’ in the tag that makes up the specific field, the specific field is determined to be a field for entering a password and then the first flag may be set for the layer to display the specific field. Similar to the case for DRM content reproduction, the composer 320 confirms the flag for the layer and leaves the layer out of the screen to be recorded. In another embodiment, instead of setting the first flag for the layer to display the specific field e.g., for entering a password, a particular image, such as, a mosaic image, may be displayed where the specific field is supposed to be displayed, thus generating a recorded screen with the specific field hidden therefrom. To do this, the controller 310 generates a layer to display the particular image that corresponds to the size and position of the reproduced screen of the specific field, sets a second flag for the layer, and sends the layer to the composer 320. This provides an advantage of protecting private information e.g., by not revealing the password of the user on the screen to be recorded.

Alternatively, the user may designate a particular area in the display area of the touch screen for text, images or video displayed in the particular area to not be shown later in the recorded screen. For example, if the user designates the particular area using the user interface for screen recording, the controller 310 may enable a particular image, e.g., a mosaic image, to be displayed in the particular area. To do this, the controller may generate a layer to display the particular image, sets a first flag for the layer, and sends the layer to the composer 320. The user interface for screen recording may include a menu for designating the particular area. Designation of the particular area may be made, for example, with a touch-and-drag gesture on the touch screen.

According to present invention, better user experiences may be guaranteed for a user who performs screen recording and a user who views the recorded screen.

The foregoing embodiments of the present invention may be implemented in any different methods. For example, the embodiments of the present invention may be implemented in hardware, software, or a combination thereof Implemented in software, the embodiments may be implemented with instructions, executable by one or more processors with various operating systems or platforms. Additionally, the software may be written in any of different proper programming languages, and/or may be compiled into machine-executable assembly language codes or intermediate codes, which are executed on a framework or a virtual machine.

Furthermore, the embodiments of the present invention may be implemented on processor-readable media (e.g., memories, floppy discs, hard discs, compact discs, optical discs, or magnetic tapes) having one or more programs embodied thereon for carrying out, when executed by one or more processors, the method of implementing embodiments of the present invention discussed above.

Several embodiments have been described in connection with e.g., mobile communication terminals, but a person of ordinary skill in the art will understand and appreciate that various modifications can be made without departing the scope of the present invention. Thus, it will be apparent to those ordinary skilled in the art that the invention is not limited to the embodiments described, which have been provided only for illustrative purposes.

The above-described input methods using the input devices of electronic devices according to various embodiments of the present invention may be implemented in a program command form which may be executed by various computer means and may be recorded in a computer-readable medium. The computer-readable medium may include a program command, a data file, a data structure or a combination thereof The program commands recorded in the medium may be those designed and configured for the present invention or those known to a person ordinarily skilled in the computer software field. Examples of the computer-readable recording medium include magnetic medium such as a hard disc, a floppy disc or a magnetic tape, optical recording mediums such as a CD-ROM or a DVD, a magneto-optical recording medium such as a floptical disk, and a hardware device which are configured such that a program may be stored therein and executed like a ROM, a RAM, a flash memory or the like. Examples of program commands include not only machine language codes made by, for example, a compiler but also high grade language codes which may be executed by a computer using an interpreter. The above-described hardware devices may be configured to operate as one or more software modules to execute the operations of the present invention and the converse is equally true.

While the present invention has been particularly illustrated and described with reference to certain embodiments thereof, various modifications or changes can be made without departing from the scope of the present invention. Therefore, the scope of the present invention is not limited to the described embodiments, should be defined by the scope of the following claims and any equivalents thereof.

What is claimed is:

1. A screen recording method in a terminal, the screen recording method comprising:
displaying a first screen;
executing a screen recording function for recording the first screen;
detecting a first touch input on the first screen while recording the first screen;
generating a first image effect indicating at least one of a location and movement of the first touch input on the first screen; and
storing a video file including the recorded first screen combined with the generated first image effect.

2. The screen recording method of claim 1, wherein executing the screen recording function for recording the first screen comprises displaying a user interface (UI) for controlling the screen recording function.

3. The screen recording method of claim 2, wherein executing the screen recording function for recording the first screen further comprises receiving a second touch input through the displayed UI to start recording the first screen.

4. The screen recording method of claim 2, wherein the UI overlaps the first screen.

5. The screen recording method of claim 2, wherein the UI includes a rectangular interface that overlaps a top portion of the first screen.

6. The screen recording method of claim 1, further comprising:
detecting a second touch input on the first screen while recording the first screen; and
generating a second image effect indicating at least one of a location and movement of the second touch input on the first screen.

7. The screen recording method of claim 6, wherein the stored video file includes the recorded first screen combined with the generated first image effect and the generated second image effect.

8. The screen recording method of claim 1, further comprising recording a user voice received through a microphone while recording the first screen.

9. The screen recording method of claim 8, wherein the stored video file includes the recorded first screen combined with the generated first image effect and the recorded user voice.

10. The screen recording method of claim 1, wherein generating the first image effect comprises generating time information for synchronizing the first image effect to the recorded first screen, such that when the stored video file is played, the first image effect is displayed with the recorded first screen at a first time corresponding to the first touch input and is no longer displayed with the recorded first screen at a second time corresponding to a release of the first touch input.

11. The screen recording method of claim 1, wherein detecting the first touch input on the first screen while recording the first screen comprises detecting a user touch and drag gesture, and
wherein generating the first image effect comprises:
generating a circular effect to be displayed at a position of the recorded first screen corresponding to the user touch; and
generating a path effect to be displayed across the recorded first screen corresponding to the drag gesture.

12. The screen recording method of claim 1, further comprising:
executing an application corresponding to the first touch input;
displaying an application screen corresponding to the executed application; and
recording the application screen.

13. The screen recording method of claim 12, wherein the stored video file includes the recorded first screen combined with the generated first image effect and the recorded application screen.

14. An apparatus, comprising:
a touchscreen display;
a memory; and
a processor configured to:
display a first screen on the touchscreen display;
execute a screen recording function for recording the first screen;
detect a first touch input on the first screen while recording the first screen;
generate a first image effect indicating at least one of a location and movement of the first touch input on the first screen; and
store, in the memory, a video file including the recorded first screen combined with the generated first image effect.

15. The apparatus of claim 14, wherein the processor is further configured to execute the screen recording function for recording the first screen by displaying a user interface (UI) for controlling the screen recording function.

16. The apparatus of claim 15, wherein the processor is further configured to execute the screen recording function for recording the first screen by receiving a second touch input through the displayed UI to start recording the first screen.

17. The apparatus of claim 15, wherein the UI overlaps the first screen.

18. The apparatus of claim 15, wherein the UI includes a rectangular interface that overlaps a top portion of the first screen.

19. The apparatus of claim 14, wherein the processor is further configured to:
detect a second touch input on the first screen while recording the first screen; and
generate a second image effect indicating at least one of a location and movement of the second touch input on the first screen.

20. The apparatus of claim 19, wherein the stored video file includes the recorded first screen combined with the generated first image effect and the generated second image effect.

21. The apparatus of claim 14, further comprising a microphone,
wherein the processor is further configured to record a user voice received through the microphone while recording the first screen.

22. The apparatus of claim 21, wherein the stored video file includes the recorded first screen combined with the generated first image effect and the recorded user voice.

23. The apparatus of claim 14, wherein the processor is further configured to generate the first image effect by generating time information for synchronizing the first image effect to the recorded first screen, such that when the stored video file is played, the first image effect is displayed with the recorded first screen at a first time corresponding to the first touch input and is no longer displayed with the recorded first screen at a second time corresponding to a release of the first touch input.

24. The apparatus of claim 14, wherein the processor is further configured to detect the first touch input on the first screen while recording the first screen by detecting a user touch and drag gesture, and
wherein the processor is further configured to generate the first image effect by generating a circular effect to be displayed at a position of the recorded first screen corresponding to the user touch; and generating a path effect to be displayed across the recorded first screen corresponding to the drag gesture.

25. The apparatus of claim 14, wherein the processor is further configured to:
execute an application corresponding to the first touch input;
display an application screen corresponding to the executed application; and
record the application screen.

26. The apparatus of claim 25, wherein the stored video file includes the recorded first screen combined with the generated first image effect and the recorded application screen.

27. A screen recording method in a terminal, the screen recording method comprising:
displaying a first screen;
executing a screen recording function for recording the first screen;
detecting a first touch input on the first screen while recording the first screen;
generating a first image effect indicating at least one of a location and movement of the first touch input on the first screen; and
storing a video file including the recorded first screen and the generated first image effect.

28. An apparatus, comprising:
a touchscreen display;
a memory; and
a processor configured to:
display a first screen on the touchscreen display;
execute a screen recording function for recording the first screen;
detect a first touch input on the first screen while recording the first screen;
generate a first image effect indicating at least one of a location and
movement of the first touch input on the first screen; and
store, in the memory, a video file including the recorded first screen and the generated first image effect.
